(19) United States
(12) Patent Application Publication
(10) Pub. No.: US 2005/0127577 A1
(43) Pub. Date: Jun. 16, 2005

(54) Injection molded article having integral thermoplastic skin and method for making same

(76) Inventors: Andrew C. Clark, Alto, MI (US); Kevin A. Bull, Cedar Springs, MI (US); John E. Misner, Grandville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/888,035

(22) Filed: Jul. 9, 2004

Related U.S. Application Data
(60) Provisional application No. 60/529,815, filed on Dec. 16, 2003.

(51) Int. Cl. B29C 45/14

(52) U.S. Cl. 264/511; 264/259; 264/279; 264/275

(57) ABSTRACT

An injection molded article having an integral thermoplastic skin, and a method for making such an article. The article includes an injection molded substrate and a thermoplastic skin integrally bonded to the substrate during the injection molding process. The process includes the steps of opening the mold; placing the thermoplastic skin in the mold: closing the mold; injection molding the plastic substrate at a temperature, pressure, and fill rate that avoids thermal or mechanical damage to the skin; opening the mold; and removing the article from the mold. In a first refinement, the mold is pressurized prior to injection molding to force the skin into conformance with the mold. In a second refinement, the marginal edge of the skin is sandwiched between the mold halves so that the marginal edge remains free of the plastic substrate.

### BACKGROUND OF THE INVENTION

The present invention relates to injection molded articles and methods, and more particularly to injection molded articles having thermoplastic skins, and to methods for making such articles.

Injection molded articles and methods are well known. A typical manufacturing sequence is (1) close the mold, (2) inject plastic into the mold, (3) allow the injected plastic to cure or solidify, (4) open the mold, and (5) remove the article from the mold. The pressure at which the plastic is injected into the mold is typically in the approximate range of 10,000 psi to 15,000 psi. The temperature of the plastic injected into the mold is typically in the approximate range of 350° F. to 550° F.

On occasion, an injection molded article is covered with a “skin” such as a foam-backed vinyl or another thermoplastic material. The skin is applied using an adhesive between the skin and the article substrate. Applying the skin to the article is difficult, often resulting in wrinkling and/or incomplete adhesion. Such defects are unacceptable in many applications, resulting in a relatively high scrap rate. Further, the application of skins to substrates is labor intensive and consequently expensive.

Another technique for molding plastic articles is injection/compression molding. In injection/compression molding, the plastic material is placed in the partially closed mold and then the mold is fully closed to form the article. A typical manufacturing sequence is (1) partially close the mold, (2) inject the plastic material into the mold, (3) fully close the mold to compress the material into the desired shape, (4) open the mold, and (5) remove the article from the mold. In the injection phase, the plastic is introduced at a pressure in the approximate range of 3,000 psi to 5,000 psi (far lower than in injection molding) and at a temperature in the approximate range of 350° F. to 550° F. (approximately the same as in injection molding). In the compression phase, the pressure will typically be in the range of injection molding.

In one type of injection/compression molding, an integral thermoplastic skin is included on the molded article. The skin is placed in the open mold before it is partially closed. Because the plastic is injected in the injection phase at a relatively low pressure, the plastic does not mechanically damage, or even wrinkle, the skin. When the plastic material is compressed in the compression phase, it bonds with the skin to provide an article with an integral skin. An adhesive, often a heat-activated adhesive, is included on the surface of the skin facing the plastic material in order to improve the adhesion of the skin to the plastic. Unfortunately, articles so manufactured have several disadvantages. First, the skin can be distorted or even ripped during the compression phase as the plastic moves against the skin. Second, surface design parameters are limited because of the inability to compress the viscous plastic melt into the details of the mold without unacceptable distortion of the thermoplastic skin. Consequently, compression molding is not acceptable for many objects requiring surface detail. Third, compression molding can be difficult to regulate and control because the material is injected into the mold before it is fully closed. If too little material is used, the substrate is incomplete. If too much material is used, squeeze-out results—like an overfull waffle iron.

Despite the limited success of producing skinned articles using injection/compression molding, the common wisdom among those skilled in the art is that it is impossible to injection mold articles having integral thermoplastic skins. The relatively high pressures and fill rates associated with injection molding have been expected to mechanically and thermally degrade the skin within the mold, which would result in totally unacceptable articles.

### SUMMARY OF THE INVENTION

The aforementioned problems are overcome in the present invention wherein an article including an integral thermoplastic skin is created using injection molding. More specifically, (1) the skin is placed into the open mold, (2) the mold is closed, (3) the injection molded material is introduced at a temperature, pressure, and flow rate so as not to thermally or mechanically degrade the skin, (4) the mold is opened, and (5) the article is removed. A balance is struck between having the plastic cold enough to avoid thermal damage to the skin, and hot enough to flow to the end of the mold before solidifying. A balance is also struck between using a pressure and flow rate low enough to avoid mechanically damaging (e.g. wrinkling) the skin, and high enough so that the plastic will flow to the end of the mold before solidifying.

In a first further refinement of the invention, the mold is pressurized after the mold is closed and before the plastic is injected. This prepressure results in several advantages. First, it forces the thermoplastic skin into close conformance with the mold before the plastic is injected. Second, it impedes the flow of the plastic material to provide a relatively uniform flow rate and relatively uniform flow front as the plastic fills the mold.

In a second further refinement of the invention, the marginal edge of the thermoplastic skin is captured between the mold halves. Accordingly, the plastic subsequently injected into the mold does not cover the marginal edge. Consequently, the marginal edge of the skin extends beyond the plastic. After the article is removed from the mold, the marginal edge of the skin can be folded around the plastic substrate, providing a finished and trim edge treatment.

These and other objects, advantages, and features of the invention will be more fully understood and appreciated by reference to the description of the preferred embodiment and the drawings.

### BRIEF DESCRIPTION OF THE DRAWINGS

FIG. 1 is a plan view of an automotive seat back and map pocket of the present invention;

FIG. 2 is a plan view of the seat back after it is removed from the mold but before the edge of the skin is wrapped around the substrate;

FIG. 3 is a plan view of the opposite side of the seat back shown in FIG. 2;

FIG. 4 is a perspective view of the opposite side of the seat back with the marginal edge of the skin wrapped around the substrate;

FIG. 5 is a perspective view of the cavity mold half;

FIG. 6 is a perspective view of the core mold half;

FIG. 7 is a sectional view through the closed injection mold with nothing inside the mold;

FIG. 8 is a sectional view of the opened injection mold with the skin hung in the mold;

FIG. 9 is a perspective view of the mold in the position illustrated in FIG. 8;

FIG. 10 is a sectional view similar to FIG. 8 but with the mold closed;

FIG. 11 is a sectional view similar to FIG. 10 and with the plastic substrate injection molded into the mold;

FIG. 12 is a sectional view of the seat back removed from the mold; and

FIG. 13 is a perspective view of both mold halves and the seat back after the mold is opened.

### DESCRIPTION OF THE CURRENT EMBODIMENT

I. Injection Molded Article

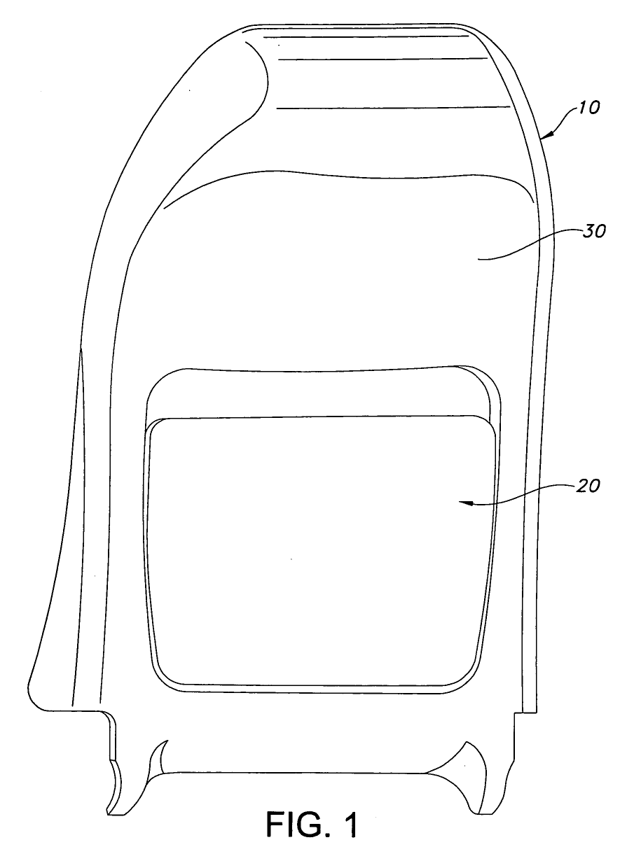

Two articles constructed in accordance with a preferred embodiment of the invention are illustrated in FIGS. 1-4 and generally designated 10 and 20. The two items are an automotive seat back 10 and an associated map pocket 20, both intended for incorporation into an automotive seat assembly. The map pocket 20 is attached to the seat back 10 and can be moved with respect thereto to provide access to a map storage space. Because both items are fabricated using the same process described in this specification, the remainder of this specification will discuss only the seat back 10.

The seat back 10 includes a thermoplastic skin 30 and a substrate 40. The majority of the skin is bonded to the substrate 30 during injection molding as will be described.

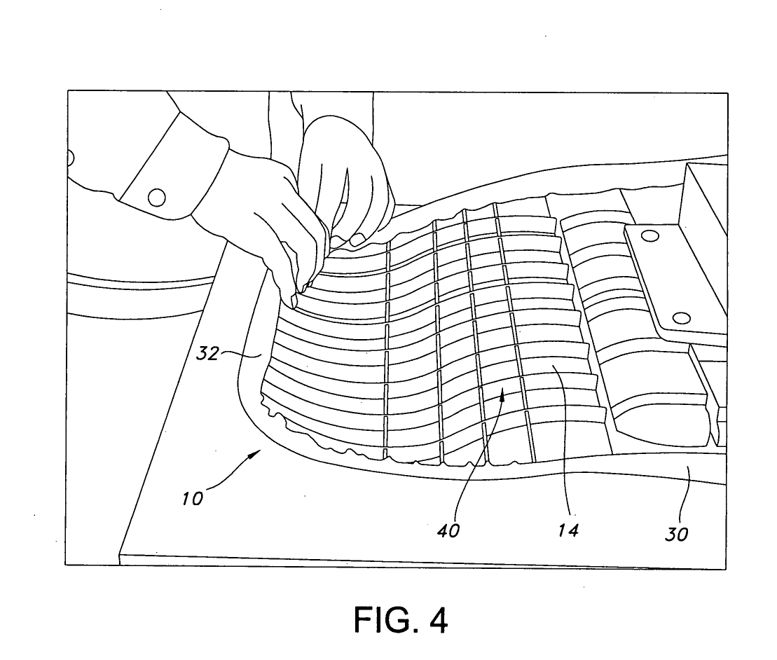

In the current embodiment, the thermoplastic skin 30 is a foam-backed vinyl such as that sold as product number 8102Z-SZ23A-A000 by Okamoto USA, Inc. of Stratford, Conn. The vinyl in this material is polyvinyl chloride (PVC), and the foam backing is polypropylene. Other materials can be used depending on the application and will be known to those skilled in the art. The skin 30 includes a marginal portion 32 extending beyond and not bonded to the substrate 40 when the article is removed from the mold. As illustrated in FIG. 4, after the article is removed from the mold, the marginal portion 32 is wrapped around the edge of the substrate to provide a finished and neat appearance. The skin 30 also includes a gate marginal portion 34 extending beyond the substrate 40. The gate marginal portion 34 includes a plurality of holes 36 for mounting the skin 30 in the injection mold as will be described. Following molding, the mounting marginal portion 34 is trimmed and/or folded about the edge of the substrate 40 to provide a neat and finished appearance.

The substrate 40 of the current embodiment is an injection molded plastic. In the current embodiment, the substrate 40 is a polypropylene with nanocomposites sold under the FORTE trademark by Noble Polymers, L.L.C. of Grand Rapids, Mich. This material has a melt flow of 27. Other suitable materials, including most thermoplastics, will be known to those skilled in the art.

In the current embodiment, the substrate and the skin are compatible, resulting in two advantages. First, the two materials bond to one another during injection molding. Second, the seatback can be more easily recycled. The substrate and skin also can be incompatible materials. However, in that case an adhesive may be required to provide bonding or adhesion. In view of the elevated temperatures involved in injection molding, a heat-activated adhesive would be an appropriate choice.

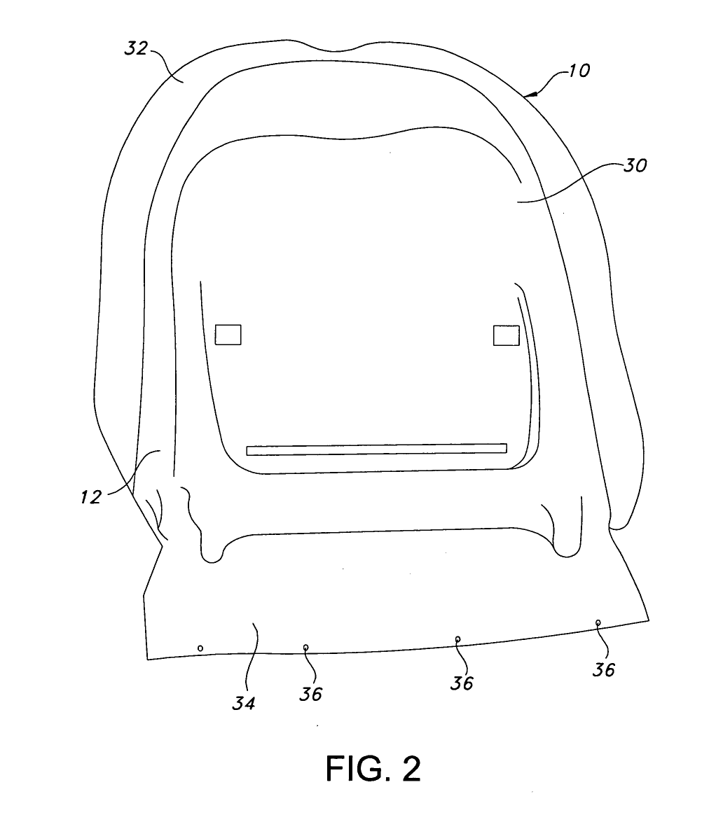

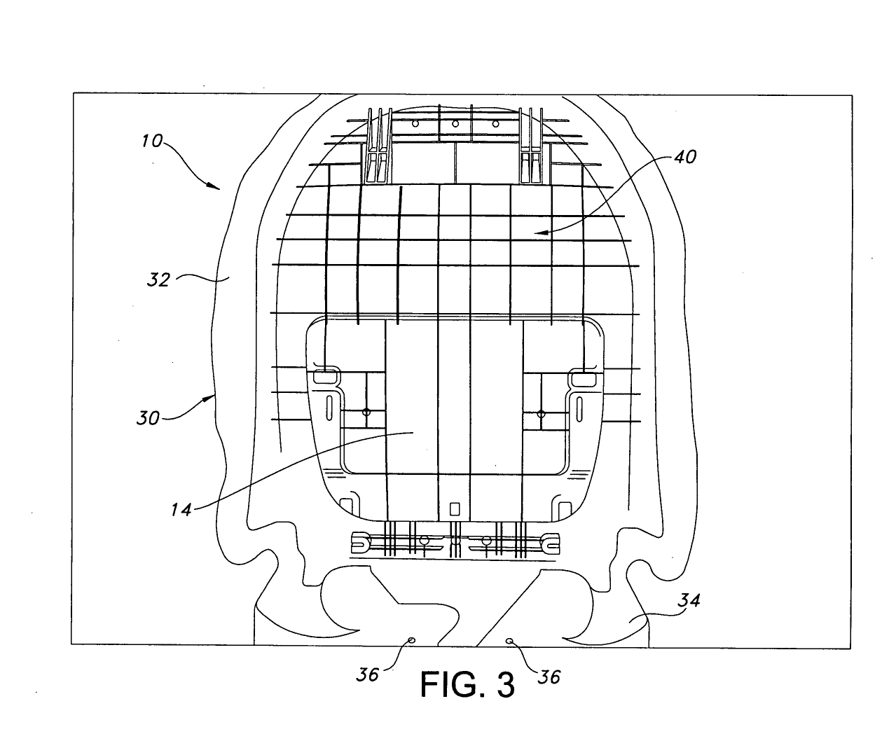

The rear surface 12 of the substrate 40 (FIG. 2) is the exposed or visible portion of the seat back 10 in an assembled automotive seat. The skin 30 is bonded to the rear surface 12. The front surface of the substrate 40 (FIG. 3) includes a plurality of ribs for strength and reinforcement. The number and pattern of ribs illustrated is exemplary only. Additionally, attachment devices and other mechanical features are incorporated into the substrate 40 as is known in the art to permit the substrate to be attached, mounted or otherwise utilized in a larger assembly.

II. Injection Molding Mold

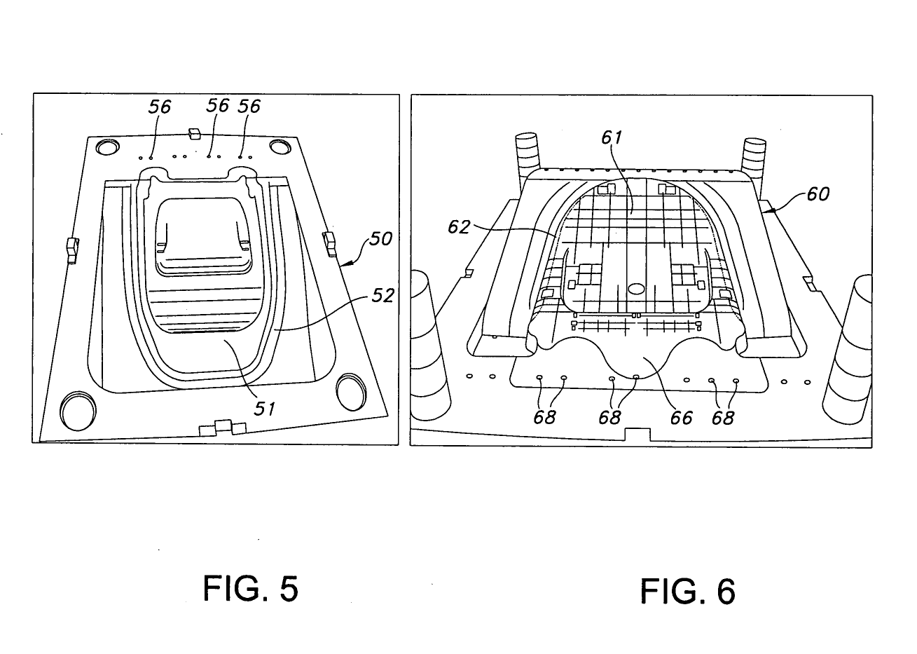

The mold halves 50 and 60 used in the injection molding process to create the seat back 10 are illustrated in FIGS. 5-11 and 13. The cavity mold half 50 defines the rear surface of the seat back 10, and the core mold half 60 defines the front surface of the substrate 40. The configuration of the mold halves depends on the article being produced.

The cavity mold half 50 defines the rear surface of the seat back 10. Specifically, the mold half 50 defines a cavity portion 51 and a marginal portion 52 surrounding the cavity portion. A plurality of pins 56 (FIG. 5) extend from the mold half 50 to provide a means for suspending the skin within the mold. Suction cups could be included to replace or to supplement the pins 56.

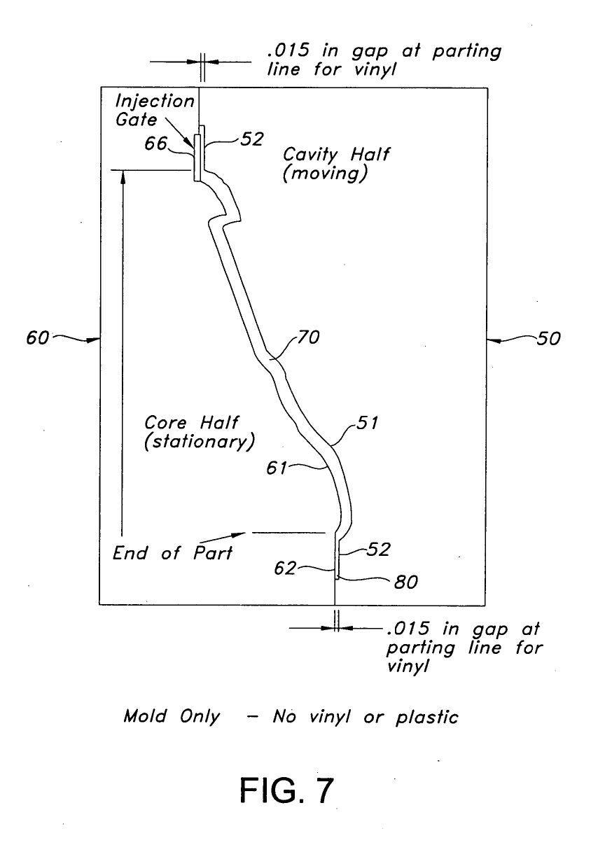

The core mold half 60 defines the front surface of the seatback 10. Specifically, the mold half 60 includes a cavity portion 61, a marginal portion 62 surrounding the cavity portion, and a gate 66 at one end of the cavity portion. When the mold halves are closed, the cavity portions 51 and 61 cooperate to form a cavity 70 (FIG. 7). The gate 66 communicates with the cavity 70 to provide a means for injection molding plastic into the mold. In the current embodiment, the gate 66 is a fan gate, but other gate configurations could be used. Preferably the gate is relatively long to provide a means for cooling the plastic material as it travels between the injector and the mold cavity. The core mold half 60 defines a plurality of holes 68 (FIG. 6) for receiving the pins 56 on the opposite mold half when the mold is closed.

A sectional view through the closed mold halves 50 and 60 is illustrated in FIG. 7. The marginal portions 52 and 62 of the mold halves 50 and 60, respectively, in the closed mold define a controlled gap 80 of 0.015 inch to receive the marginal portion 32 of the skin 30 as will be described. Different spacings for different materials and applications will be obvious to those skilled in the art.

III. Injection Molding Process

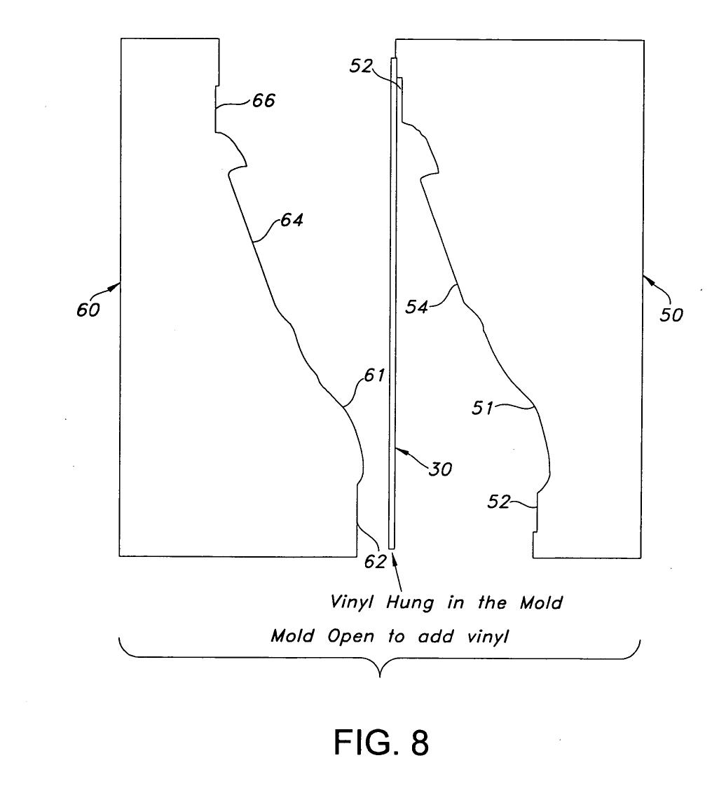

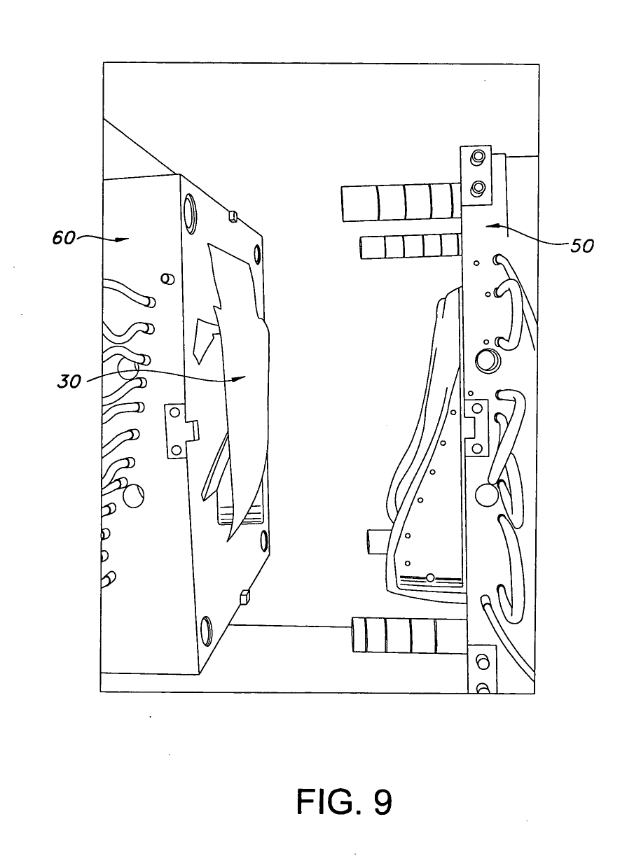

To begin the manufacturing sequence, the mold must be open as illustrated in FIGS. 8 and 9. A skin 30 is placed in the open mold, and more particularly the skin is hung on the cavity mold half 50 by fitting the holes 36 in the skin 30 over the pins 56. When the mold is open, the skin hangs freely.

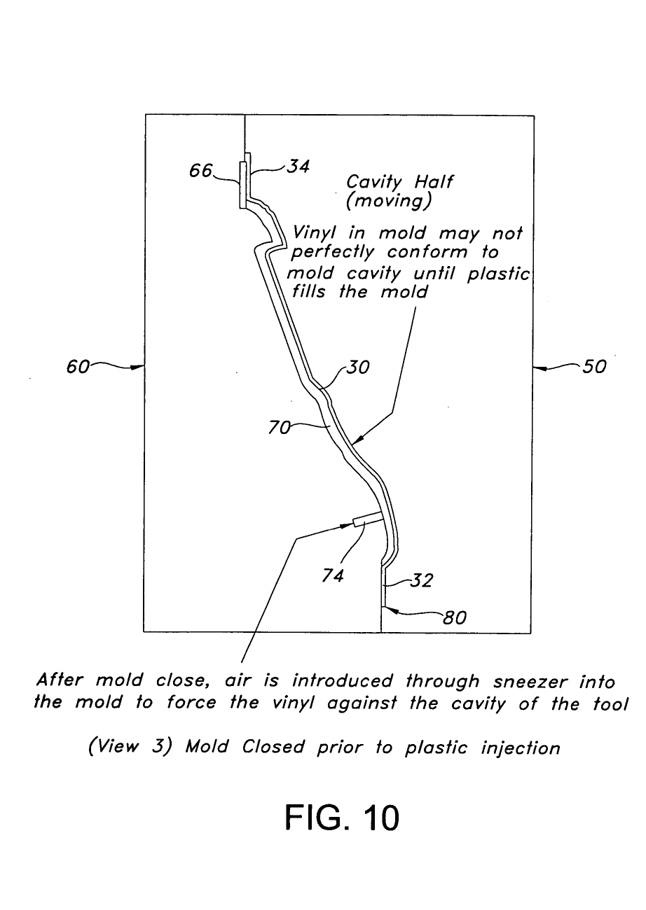

The mold is then closed so that the mold halves 50 and 60 come into contact with one another as illustrated in FIG. 10. The marginal portion 32 of the skin 30 is located within the gap 80 and is sandwiched between the two mold halves. The runner marginal portion 34 is located adjacent the gate 66 and also is sandwiched between the two mold halves. The location of the marginal portion 32 within the gap 80 prevents subsequently injected plastic from contacting the marginal portion.

As also illustrated in FIG. 10, a pressure differential is created within the closed mold to force the skin 30 into conformance with the cavity portion 51 of the cavity mold half 50. In the current embodiment, this pressure differential is created by introducing pressurized air or another gas into the mold cavity through the die half 60. Even more specifically, the pressurized air is introduced through “sneezers” 74, which are sintered pieces through which gas may pass but through which injection molded plastic cannot pass. In the current embodiment, the mold is pressurized to approximately 40 psi so that this function can be performed with “shop air”, avoiding more expensive options such as nitrogen. This pressure has been found to adequate both to conform the skin to the mold and to provide backpressure for the injection molded plastic as will be described. Other techniques for creating the pressure differential will be known to those skilled in the art and include, for example, drawing a vacuum through the die half 50. Pressurizing a mold before injection molding to assist in controlling flow rates and flow fronts is a known prior art technique. However, pressurizing a mold to conform a skin to a mold is believed to be novel.

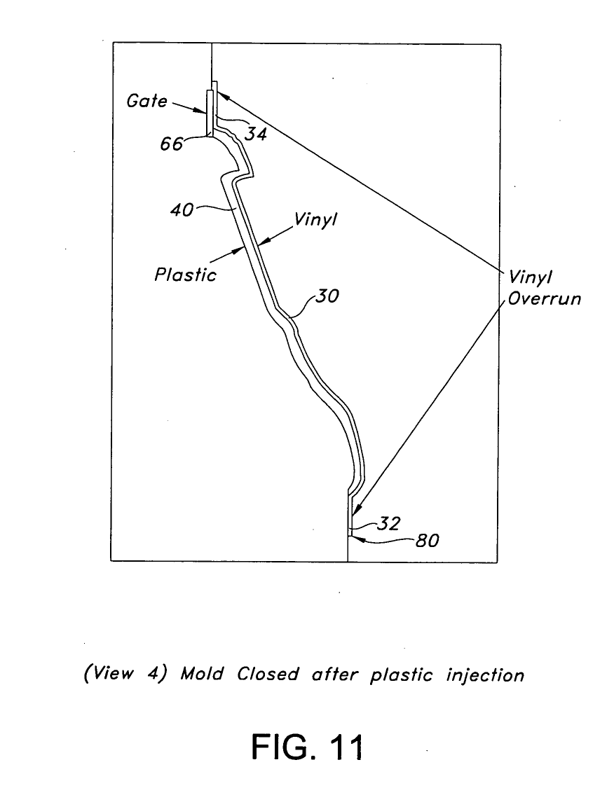

Plastic is then injected into the cavity 70 through the gate 66 to create the substrate 40. The plastic material is introduced through the gate 66 and fills the mold from the gate to the end of the cavity, which is at the lower portion of FIG. 11. The length of the gate 66 provides the plastic with an opportunity to cool somewhat before it contacts the skin 30 within the mold. The gas within the mold provides backpressure to help provide a uniform flow rate and a uniform flow front as the plastic fills the mold. In the current embodiment, the temperature of the plastic at the injector nozzle is approximately 360° F.; the pressure of the plastic at the injector nozzle is approximately 10,000 psi; the pressure of the plastic at the end of the mold opposite the gate 66 at the conclusion of the fill is approximately 3,000 psi; and the fill rate is approximately 12.9 cubic inches per second for the total fill of approximately 130 cubic inches. In the current embodiment, the pressure is constant during the entire fill. In other applications, it may be desirable to vary the pressure profile of the fill. Particular temperatures, pressures, and fill rates will depend on the materials and on the article being manufactured. It also is possible to use other known techniques, such as gas assist, to facilitate moving the plastic into the mold.

As disclosed, the plastic is compatible with the skin. Accordingly, as the material fills the mold, the plastic bonds to the skin 30. If the plastic and the skin are incompatible, then adhesive may be required for adequate bonding or adhesion. Suitable adhesives will be known to those skilled in the art, and typically the adhesive would be applied to the skin during manufacture of the skin.

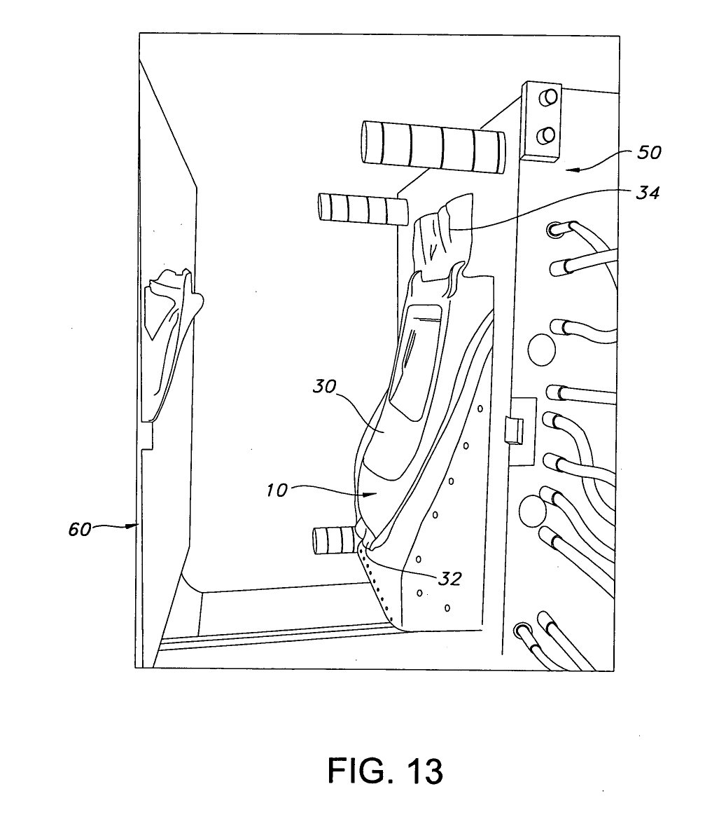

After the plastic cures or solidifies, the mold is opened as illustrated in FIG. 13 so that the mold halves 50 and 60 are separated from one another. The skin 30 smoothly releases from the cavity mold half 50, so that the seatback part is on the core mold half 60. The seat back 10 is removed from the core mold half 60 using ejector pins or other techniques known in the art.

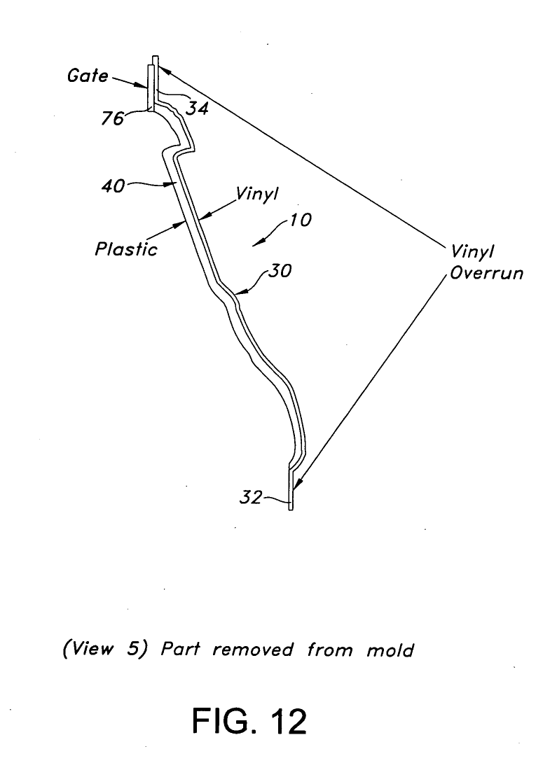

When the seat back 10 is removed from the mold (FIG. 12), the marginal portion 32 of the skin 30 extends beyond the substrate 40 around three edges of the substrate. Also, the gate portion 34 of the skin 30 extends beyond the fourth edge of the substrate 40, and also a gate portion 76 of the plastic remains integral with the substrate. In one subsequent operation, the gate portion 76 and the marginal portion 34 adhered thereto are cut or otherwise removed from the article. In another subsequent operation illustrated in FIG. 4, the marginal portion 32 is folded about the injection molded substrate 40 to provide the finished appearance. It is possible that these two operations could be performed as a single step and/or in a single machine.

The parting line of the mold halves is at the edge of the substrate. Consequently, the parting lines in the substrate 40 are in an aesthetically acceptable location.

Important considerations in the present application are the temperature, pressure, and rate at which the plastic is injection molded in view of the skin and plastic materials. The plastic must be hot enough and the pressure must be high enough to enable the plastic to reach the end of the mold before the plastic begins to solidify. At the same time, the plastic must be cool enough to avoid thermally damaging the skin, and the pressure must be low enough to avoid wrinkling or mechanically damaging the skin. Additionally, the latent heat of the plastic must be sufficiently low so that it does not cause the skin to bubble or otherwise deface after the plastic has been injected into the mold. Selections of other materials, temperatures, pressures, and fill rates will be apparent to those skilled in the art.

While the current embodiment of the mold and process utilizes a gate, the present invention is equally applicable to molds and process utilizing different size gates, sub-gates, or even no gate.

In the preferred embodiment, the map pocket 20 includes inner and outer halves that are commonly molded in a “family mold” of a type generally known in the art. In such an arrangement, the two halves are injected in a common mold using a common fill of material.

The present invention has been described in conjunction with an automotive seat back. As previously noted, the invention is widely adaptable to a virtually limitless array of injection molded articles. Such applications are and will become apparent to those skilled in the art.

The advantages of the present invention are numerous. First, the relatively high pressures associated with injection molding enable both the skin and the plastic to have a high degree of detail. Second, the ability to injection mold skinned parts provides a greater choice of materials in making such parts. Third, when the skin and substrate materials are compatible, there is no need for adhesive. Fourth, and again when the skin and substrate are compatible, the part is easily recycled.

The above description is that of a preferred embodiment of the invention. Various alterations and changes can be made without departing from the spirit and broader aspects of the invention as defined in the claims, which are to be interpreted in accordance with the principles of patent law including the doctrine of equivalents.

1. A method of making an injection molded article comprising the steps of:
placing a thermoplastic skin between two mold halves;
closing the mold halves to define a mold cavity;
injection molding plastic into the mold cavity at a temperature, a pressure, and a flow rate that enables the plastic to fill the mold before the plastic solidifies and that avoids thermally or mechanically damaging the thermoplastic sheet;
opening the mold halves; and
removing the article from the mold halves.

2. A method as defined in claim 1 further comprising, after said closing step and before said injection molding step, the step of creating a pressure differential on opposite sides of the thermoplastic skin to force the thermoplastic skin against one of the mold halves.

3. A method as defined in claim 1 wherein said closing step includes securing a marginal portion of the thermoplastic skin between the closed mold halves.

4. A method as defined in claim 1 wherein the thermoplastic skin and the plastic are compatible with one another, whereby they bond to one another during said injection molding step.

5. A method as defined in claim 4 wherein:
the thermoplastic skin comprises a polyvinylchloride layer and a polyester foam backing; and
the plastic comprises a polyester.

6. A method as defined in claim 5 wherein the plastic has a melt flow of 27.

7. A method as defined in claim 1 wherein the thermoplastic skin includes a heat-activated adhesive engaged by the plastic.

8. A method of making an injection molded article comprising the steps of:
positioning a thermoplastic skin between closed mold halves defining a mold cavity; and
injection molding plastic material into the mold cavity on one side of the thermoplastic skin at a temperature and a pressure sufficiently high to enable the plastic material to fill the mold before solidifying, at a temperature sufficiently low to avoid thermally damaging the thermoplastic sheet, and at a pressure sufficiently low to avoid mechanically damaging the thermoplastic skin.

9. A method as defined in claim 8 further comprising, before said injection molding step, the step of creating a pressure differential within the mold cavity to force the thermoplastic skin into conformance with one of the mold halves.

10. A method as defined in claim 8 wherein said positioning step includes trapping a marginal portion of the thermoplastic skin between the mold halves to shield the marginal portion from the plastic material.

11. A method as defined in claim 8 wherein the thermoplastic skin and the plastic material are compatible, whereby they bond to one another during said injection molding step.

12. A method as defined in claim 11 wherein:
the thermoplastic skin comprises a polyvinylchloride sheet and a polyester foam backing; and
the plastic material comprises a polyester.

13. A method as defined in claim 12 wherein the plastic material has a melt flow of 27.

14. A method as defined in claim 8 wherein the thermoplastic skin includes a heat-activated adhesive for enhancing the bond between the skin and the plastic material.

15. A method of injection molding an article comprising the steps of:
positioning a thermoplastic skin between the mold halves;
closing the mold halves to define a mold cavity, and trapping a marginal portion of the thermoplastic skin between the closed mold halves;
creating a pressure differential within the mold cavity to urge the thermoplastic skin against one of the mold halves;
injecting molding plastic material into the mold cavity at a temperature, a pressure, and a flow rate sufficiently high to enable the plastic material to fill the cavity before the plastic material solidifies, at a temperature sufficiently low to avoid thermally damaging the thermoplastic skin, and at a pressure and a flow rate sufficiently low to avoid mechanically damaging the thermoplastic skin;
allowing the plastic material to solidify;
opening the mold halves; and
removing the article from the mold halves.
